(19) United States
(12) Patent Application Publication
(10) Pub. No.: US 2010/0041257 A1
(43) Pub. Date: Feb. 18, 2010

(54) EMI SHIELDED ELECTRICAL CONNECTOR

(75) Inventors: Timothy Michael BECK, York Haven, PA (US); Michael Scott FEHER, Steelton, PA (US); Edward J. HOWARD, Millersburg, PA (US); Navin Kanjibhai PATEL, Mechanicsburg, PA (US)

Correspondence Address: TYCO TECHNOLOGY RESOURCES, 4550 NEW LINDEN HILL ROAD, SUITE 140, WILMINGTON, DE, 19808-2952, US

(73) Assignee: TYCO ELECTRONICS CORPORATION, Berwyn, PA (US)

(21) Appl. No.: 12/191,511

(22) Filed: Aug. 14, 2008

(51) Int. Cl. H01R 13/648; H01R 13/62

(52) U.S. Cl. 439/108; 439/345; 439/607.01

(57) ABSTRACT

An electrical connector including a receptacle having receptacle having at least one shielding member and at least one electrically conductive surface. The shielding member includes at least one grounding member and at least one latching member. The grounding member is in physical contact with the electrically conductive surface and the latching member is configured to detachably engage a latching feature of a mating receptacle. A connector system and a method for shielding a connector are also disclosed.

### FIELD OF THE INVENTION

The present invention is generally directed to an electrical connector, and more particularly, to a shielded electrical connector having shielding members that provide electromagnetic interference (EMI) shielding and mechanical latching.

### BACKGROUND OF THE INVENTION

Connectors are used to provide electrical power or electrical or electronic control signals between components, such as computers, printers, auxiliary hardware, equipment, sensors, etc. These connectors are susceptible to electromagnetic interference (EMI), which may interfere or degrade electrical signals passing through the connector. EMI is broadly defined as any electromagnetic radiation released by an electronic device or other source that disrupts the operation or performance of another device.

Applications, such as medical monitoring devices, require shielded connectors that can be wiped down and/or sterilized to maintain a medically clean environment. Consistently adequate EMI shielding or minimization of EMI between components has been nonexistent or extremely difficult to achieve in medical monitoring devices. In addition, known connector systems utilize hardware components mounted externally to the connector halves for mechanical latching, which may be damaged or may interfere with the process of wiping down or sterilizing the equipment.

Therefore, what is needed is a connector system that provides an EMI shielded connector having a mechanism for mechanically latching connector halves together without the need for external latching mechanisms.

### SUMMARY OF THE INVENTION

A first aspect of the present disclosure includes an electrical connector including a receptacle having at least one shielding member and at least one electrically conductive surface. The shielding member includes at least one grounding member and at least one latching member. The grounding member is in physical contact with the electrically conductive surface and the latching member is configured to detachably engage a latching feature of a mating receptacle.

Another aspect of the present disclosure includes a connector system having a first receptacle and a second receptacle. The second receptacle is configured to mate with the first receptacle and has at least one electrically conductive surface. The system includes a shielding member having at least one grounding member and at least one latching member. The grounding member is in physical contact with the electrically conductive surface and the latching member is configured to detachably engage a latching feature of the first receptacle.

Still another aspect of the present disclosure includes a method for shielding an electrical connector. The method includes providing a first receptacle and providing a second receptacle configured to mate with the first receptacle. The second receptacle includes at least one electrically conductive surface. The method further includes providing a shielding member having at least one grounding member and at least one latching member. The shielding member is arranged and disposed so that the grounding member is in physical contact with the electrically conductive surface. The first receptacle is mated to the second receptacle. In addition, the at least one latching feature of the first receptacle is detachably engaged with the latching member.

The shielding members of the present disclosure reduce or eliminate the need for a separate latching system and EMI spring components, particularly in applications that cannot have external latches.

In addition, the connector system of the present disclosure includes latching and shielding without the need for external components, which permits the efficient wiping down and/or sterilizing of the connector system.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 shows a perspective view of a connector system according to an embodiment of the present disclosure.

FIG. 2 shows a perspective view of a connector system according to an embodiment of the present disclosure with the overmold housing removed.

FIG. 3 shows an exploded perspective view of a connector system according to an embodiment of the present disclosure with the overmold housing removed.

FIG. 4 shows an enlarged exploded view of a portion of the connector system of FIG. 3.

FIG. 5 show enlarged elevational view of a shielding member according to an embodiment of the present disclosure.

FIG. 6 show enlarged elevational view of an alternate shielding member according to an embodiment of the present disclosure.

FIG. 7 shows a cross-sectional view of a connector system according to an embodiment of the present disclosure.

Wherever possible, the same reference numbers will be used throughout the drawings to represent the same parts.

### DETAILED DESCRIPTION OF THE INVENTION

The present invention now will be described more fully hereinafter with reference to the accompanying drawings, in which a preferred embodiment of the invention is shown. This invention may, however, be embodied in many different forms and should not be construed as limited to the embodiments set forth herein; rather, these embodiments are provided so that this disclosure will be thorough and complete and will fully convey the scope of the invention to those skilled in the art.

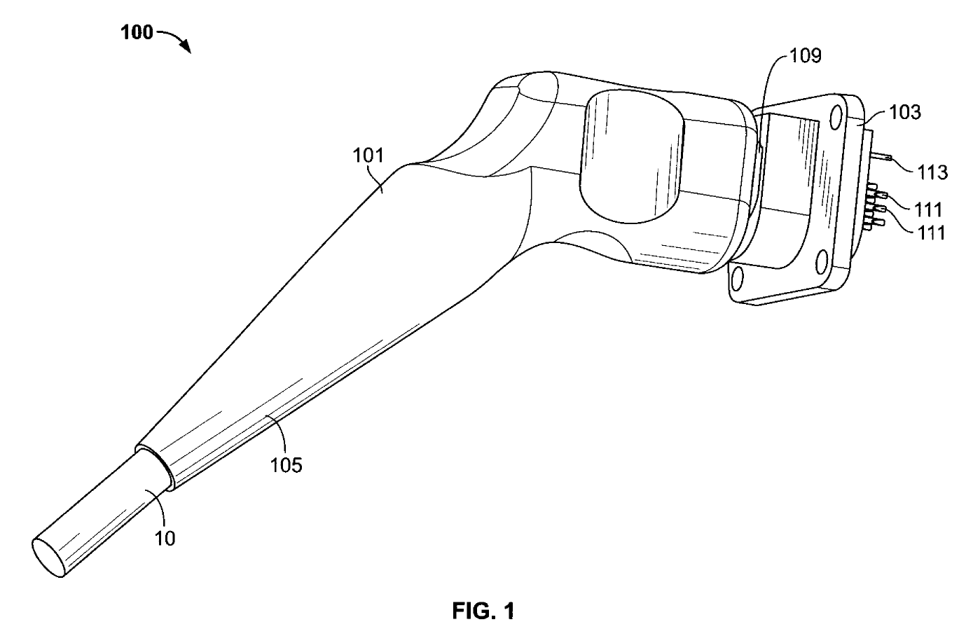

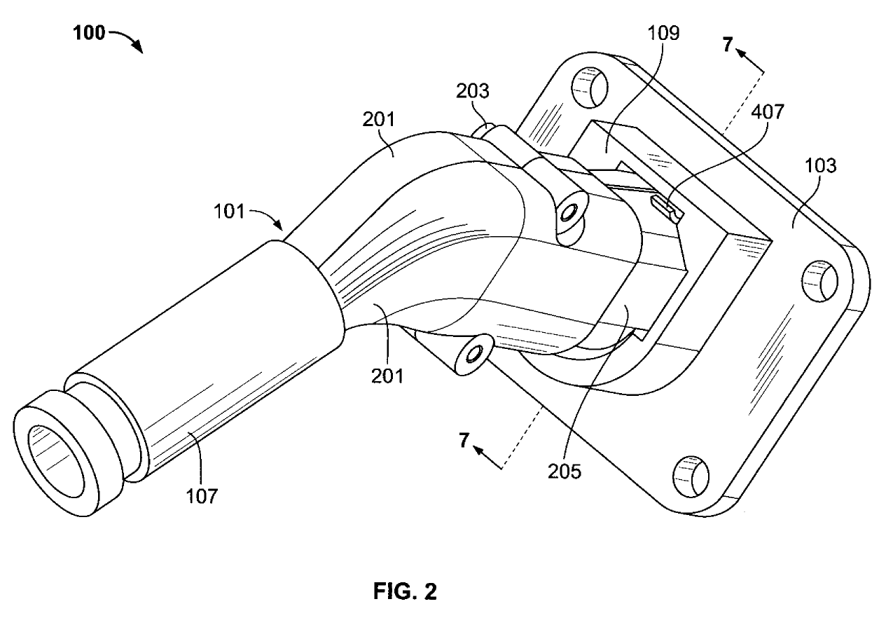

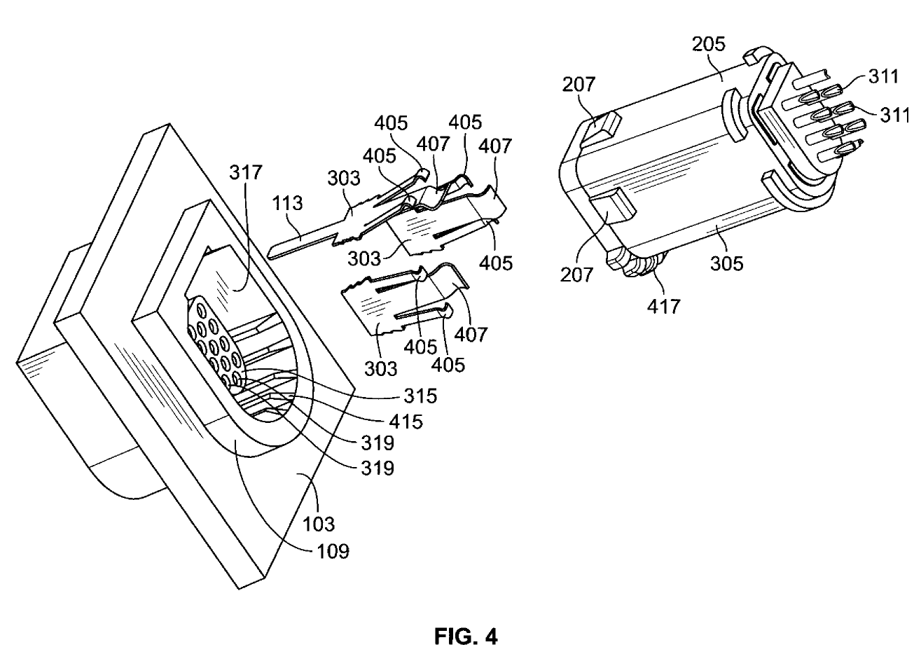

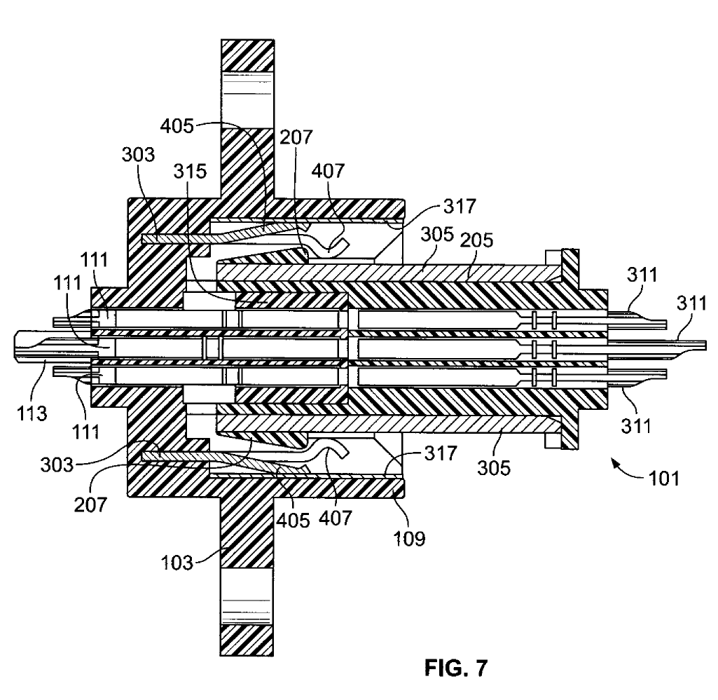

FIG. 1 shows a connector system 100 according to an embodiment of the present disclosure. The connector system 100 includes a first receptacle 101 in detachable engagement with a second receptacle 103. The first receptacle includes an overmold housing 105. The overmold housing 105 seals and surrounds internal components and provides a receptacle geometry that may be ergonomic and may be capable of being wiped down and/or medically sanitized. The overmold housing 105 may be fabricated from any suitable material, including, but not limited to polymeric materials. A cable 104 extends from under the overmold housing 105 and provides insulation and/or additional protection for the wires or other electrically conductive components. Disposed under the overmold housing 105 and/or the cable 104, the first receptacle includes a collet 107 (see FIG. 2), which provides strain relief for wires or other electrically conductive components disposed within the first receptacle 101. The second receptacle 103 includes a receptacle portion 109 having a configuration that corresponds to and mates the first receptacle 101 (see also FIG. 7). The second receptacle 103 further includes contacts 111 which are disposed within second receptacle 103 to provide electrical connectivity therethrough. “Contacts” as utilized herein, are an electrically conductive component, such as a wire, connector terminal, pin, socket, tab, combination thereof or any other component formed from an electrically conductive material. In addition, the second receptacle 103 includes a grounding tab 113 that extends through the second receptacle 103 and provides electrical grounding for shielding members 303 (see e.g., FIG. 4).

FIG. 2 shows the connector system 100 of FIG. 1 with the overmold housing 105 removed. As shown in FIG. 2, the first receptacle includes a pair of strain relief structures 201 fastened together by fasteners 203. Fasteners 203 may be any suitable fastener known in the art. In addition or alternatively, the strain relief structures 201 may be adhered together. The strain relief structures 201 provide strain relief to the wires or other electrically conductive structures disposed within the first receptacle 101 (shown with overmold housing 105 removed). The strain relief structures 201 may be fabricated from any suitable insulative material, including but not limited to a polymeric material. The collet 107 is disposed over a portion of the strain relief structure 201 and provides additional strain relief. The collet 107 further provides additional clamping or retaining force on the wires or other electrically conductive structures disposed within the first receptacle 101. At the end of the strain relief structure 201 opposite the collet 107, the strain relief structures 201 are disposed around a receptacle contact insert assembly 205. The receptacle contact insert assembly 205 mates the second receptacle at the receptacle portion 109. The receptacle contact insert assembly 205 is engaged to the second receptacle 103 by engagement of a shielding member 303 with latching feature 207 on the receptacle contact insert assembly 205 (see FIGS. 4 and 7).

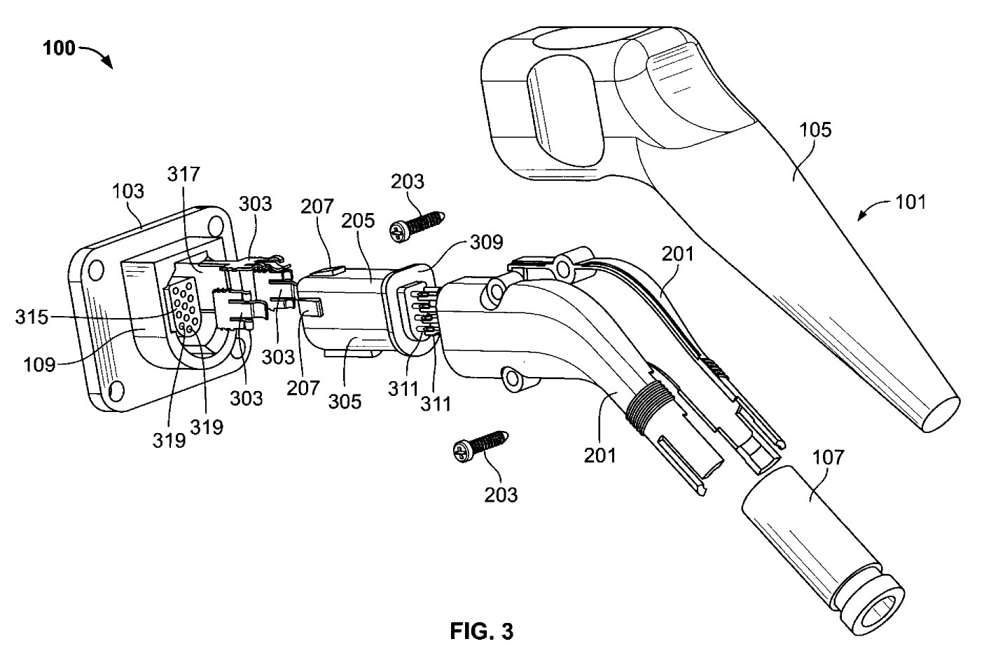

FIG. 3 shows an exploded view of connector system 100. As shown in FIG. 3, the receptacle contact insert assembly 205 includes a plurality of contacts 311. The contacts 311 may be retained in position within the receptacle contact insert assembly 205 by any suitable contact support structure 309, such as an insulative or dielectric material. The contacts 311 may be electrically connected to wires or other electrically conductive structures (not shown) that may be disposed within the strain relief structures 201 and collet 107 and provide electrical connectivity therethrough. The receptacle contact insert assembly 205 includes an electrically conductive body 305. The electrically conductive body 305 is disposed around the contact support structure 309. The electrically conductive body 305 may be fabricated from any suitable electrically conductive material, such as, but not limited to nickel plated die cast zinc, nickel plated thermoplastic or nickel plated machined aluminum. The electrically conductive body 305 includes latching features 207 disposed along edges of the receptacle contact insert assembly 205. The latching features 207 may be any suitable latching feature, including, but not limited to, protrusions, slots, indentations or other features that permit latching and retention of the first receptacle 101 to the second receptacle 103.

The second receptacle 103 includes a receptacle portion 109 that has an inner receptacle structure 315 and a grounding surface 317. The inner receptacle structure 315 includes a plurality of openings 319 into which contacts 111 may be disposed (see e.g., FIG. 1). The openings 319 and contacts 111 are arranged to provide electrical communication between contacts 111 and contacts 311 when the first receptacle 101 and second receptacle 103 are engaged together. The receptacle portion 109 further includes a grounding surface 317. The grounding surface 317 is a coating or structure made up of an electrically conductive material. While not so limited, the grounding surface 317 may include, but is not limited to nickel-plating, machined and/or stamped-and-formed nickel-plated copper sleeve components. The grounding surface 317 is preferably circumferentially disposed about an inner surface of the receptacle portion 109. Preferably, the grounding surface 317 is disposed around the connection between the first receptacle 101 and the second receptacle 103, when engaged. Surrounding the connection with the grounding surface 317 provides at least some shielding from EMI. As best seen in FIG. 4, and while not so limited, the receptacle portion 109 may include keying features 415 along an inner surface. The keying features 415 correspond to corresponding keying features 417 disposed on first receptacle contact insert assembly 205. The keying features 415, 417 may include slots, protrusions, indentations or other geometries suitable for positioning and/or guiding the receptacle contact insert assembly 205 into an engaged position. The keying features 415, 417 reduce or eliminate misalignment and prevent utilization of improper receptacle geometries.

In addition, the second receptacle 103 includes a plurality of shielding members 303 that are mounted in or in close proximity to the second receptacle 103. The shielding member 303 may be mounted by any suitable technique, including but not limited to press-fitting the shielding members 303 into the second receptacle 103. As shown in FIGS. 4-6, the shielding members 303 include a plurality of finger-like members extending therefrom. In particular, each shielding member 303 includes two grounding members 405 and a latching member 407. The grounding members 405 are configured to physically contact the grounding surface 317 of the second receptacle 103 when mounted into or in close proximity to the receptacle portion 109. The grounding members 405 are preferably configured into a spring-like configuration, such that the grounding members 405 may elastically deform when in contact with the electrically conductive surface 317 and maintain the physical and electrical connection. The grounding members 405 may include any features, protrusions or geometry that permits and retains physical contact between the grounding member 405 and the grounding surface 317 when the shielding member 303 is positioned in or in close proximity to the second receptacle.

The latching member 407 extends from the shielding member 303 and provides one or more surfaces that detachably latch, engage or otherwise catch, the latching features 207 of the receptacle contact insert assembly 205. Like the grounding members 405, the latching members 407 are preferably configured into a spring-like configuration, such that the latching members 407 may elastically deform when in contact with the latching features 207 and maintain the physical and electrical connection to the electrically conductive body 305.

The shielding member 303 is fabricated from any suitable electrically conductive material. Suitable materials for formation of the shielding members 303 include, but are not limited to, metal, such as copper, copper alloys or stainless steel, plated metal (e.g., brass, phosphor bronze) and other materials that have reliable spring-like, elastic properties having resistance to heat and/or material creep.

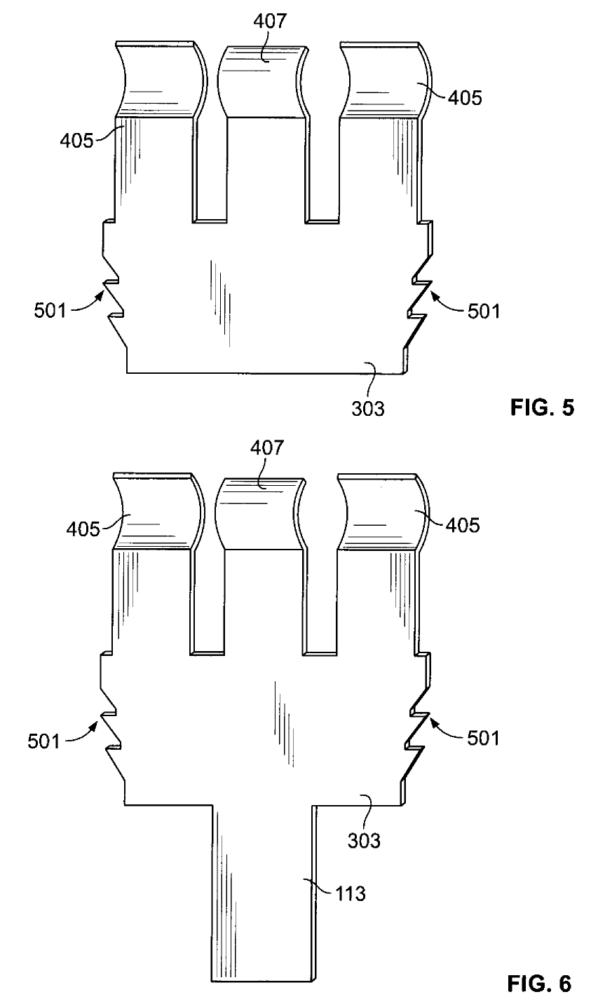

As shown in FIGS. 5 and 6, the shielding member 303 may include retention features 501 which retain the shielding members 303 in position when mounted in or in close proximity to the second receptacle 103. The retention features 501 may include, but are not limited to, a jagged or triangular geometry that substantially prevents disengagement of the shielding member 303 from the receptacle portion 109. In addition, as shown in FIG. 6, at least one of the shielding members 303 includes a grounding tab 113. The grounding tab extends through the second receptacle 103 and provides electrical communication with the shielding members 303, the grounding surface 317, and the electrically conductive body 305. The combination of the shielding members 303, the grounding surface 317, and the electrically conductive body 305 provides EMI shielding, wherein EMI or other interference is captured. The ground tab 113 may then terminate a ground wire or other grounding structure (not shown) to the ground tab 113 to carry interference signals (e.g., EMI) to ground.

FIG. 7 shows a cross-sectional view of the connector system 100 of FIG. 2, taken in direction 7-7. The first receptacle 101 and the second receptacle 103 are detachably engaged together. To provide electrical connectivity, contacts 111 engage contacts 311 and provide electrical communication therebetween. The connection may include any suitable known connection and may include, but is not limited to, a pin and socket arrangement. As visible in FIG. 7, the shielding members 303 include a grounding member 405 and a latching member 407. The grounding member 405 is in physical contact with the grounding surface 317 of the receptacle portion 109. The grounding member 407 extends in an opposite direction as the grounding member 405 and engages the latching feature 207 of the receptacle contact insert assembly 205. The grounding member 405 provides electrical communication between the shielding member 303 and the grounding surface 317. Likewise, the latching member 407 provides retention of the first receptacle 101 to the second receptacle 103 and electrical communication between the shielding member 303 and the electrically conductive body 305.

The configuration of the connector system 100 provides an internal latching and shielding that is cooperable with a continuous, ergonomic overmold housing 105, which permits wiping and/or sterilizing without damaging the first receptacle 101. The configuration is suitable for applications requiring signal transfer, including high-speed data transfer, between a medical device and a medical sensor. For example, the second receptacle 103 may be a receptacle mounted on a medical device and the first receptacle 101 may be a lead wire or other wire connected to a medical sensor.

While the above has been shown and described as a medical monitoring device, the disclosure is not so limited. For example, the connector system 100 of the present disclosure may be utilized with any type of equipment susceptible to EMI. For example, scientific instrumentation, such as temperature measurement or control systems requiring connectivity may be exemplary applications for the connector system 100 of the present disclosure.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An electrical connector comprising:
a receptacle, the receptacle having at least one shielding member and at least one electrically conductive surface, the shielding member including at least one grounding member and at least one latching member; and
wherein the grounding member is in physical contact with the electrically conductive surface and the latching member is configured to detachably engage a latching feature of a mating receptacle.

2. The receptacle of claim 1, wherein the shielding member is press-fit into the receptacle.

3. The receptacle of claim 1, wherein the shielding member further includes retention features to resist disengagement from the receptacle.

4. The receptacle of claim 1, wherein the shielding member further comprises a grounding tab that extends through the receptacle.

5. The receptacle of claim 1, wherein the receptacle further includes keying features for alignment with the mating receptacle.

6. The receptacle of claim 1, wherein receptacle includes at least two shielding members.

7. A connector system comprising:
a first receptacle;
a second receptacle configured to mate the first receptacle, the second receptacle having at least one electrically conductive surface;
a shielding member having at least one grounding member and at least one latching member; and
wherein the grounding member is in physical contact with the electrically conductive surface and the latching member is configured to detachably engage a latching feature of the first receptacle.

8. The connector system of claim 7, wherein the shielding member is press-fit into the second receptacle.

9. The connector system of claim 7, wherein the shielding member further includes retention features to resist disengagement from the second receptacle.

10. The connector system of claim 7, wherein the shielding member further comprises a grounding tab that extends through the second receptacle.

11. The connector system of claim 7, wherein the second receptacle includes at least two shielding members.

12. The connector system of claim 7, wherein the second receptacle further includes keying features for alignment with the mating receptacle.

13. The connector system of claim 7, wherein the first receptacle further includes an electrically conductive body.

14. The connector system of claim 13, wherein the shielding members, the at least one electrically conductive surface and the electrically conductive body are in electrical communication.

15. The connector system of claim 13, wherein the shielding members, the at least one electrically conductive surface and the electrically conductive body provide resistance to electromagnetic interference.

16. The connector system of claim 7, wherein the first receptacle includes an overmold housing that is capable of being wiped down or sanitized.

17. A method for shielding an electrical connector
providing a first receptacle;
providing a second receptacle configured to mate the first receptacle, the second receptacle having at least one electrically conductive surface;
providing a shielding member having at least one grounding member and at least one latching member; and
arranging and disposing the shielding member so that the grounding member is in physical contact with the electrically conductive surface; and
mating the first receptacle to the second receptacle and detachably engaging at least one latching feature of the first receptacle with the latching member.

18. The method of claim 17, wherein the first receptacle further includes an electrically conductive body.

19. The method of claim 18, wherein the shielding members, the at least one electrically conductive surface and the electrically conductive body are in electrical communication.

20. The method of claim 18, wherein the shielding members, the at least one electrically conductive surface and the electrically conductive body provide resistance to electromagnetic interference.
